(19) United States
(12) Patent Application Publication
(10) Pub. No.: US 2007/0194894 A1
(43) Pub. Date: Aug. 23, 2007

(54) Method and apparatus for electronic storing of calibration/identification data for a wireless linear passive sensor

(76) Inventors: John Peter Beckley, Bicester (GB); Paul Edward Vickery, Towcester (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 10/592,172

(22) PCT Filed: Feb. 18, 2005
(86) PCT No.: PCT/GB05/00577

§ 371 Date: Sep. 8, 2006

(30) Foreign Application Priority Data
Mar. 11, 2004 (GB) 0405503.4

(51) Int. Cl. B60C 23/00; G08B 29/00

(52) U.S. Cl. 340/447; 340/511

(57) ABSTRACT

A passive sensor arrangement comprising a plurality of sensors (6) for monitoring environmental parameters at a number of separate locations (5), each sensor (6) requiring individual calibration. An interrogation system (2) receives and analyses data from the sensor (5), and a memory (1) is associated with each sensor (6) for storing the individual calibration data its associated sensor. Each sensor position has a memory card slot associated with it such that calibration information carried on a memory card inserted into a particular slot is automatically associated with the sensor in that position. In this way, calibration information for the sensors can easily be updated when sensors are moved or replaced by simply moving the associated memory card into a different slot or replacing the memory card with a new one carrying the calibration data for the replacement sensor.

### CROSS REFERENCE TO RELATED APPLICATIONS

This application claims the benefit of PCT Application No. PCT/GB2005/000577, filed Feb. 18, 2005, and GB Application 0405503.04, filed Mar. 11, 2004, both of which are herein incorporated by reference.

### BACKGROUND OF THE INVENTION

1. Field of the Invention

The present invention relates to calibration data storage for wireless linear passive sensors.

2. Description of the Related Art

There are inherent problems with storing information on a linear passive device such as a SAW (Surface Acoustic Wave) device. The main limiting factor is the amount of data that can be stored. If a SAW resonator is used then any information encoded into the device will be within the frequency of the device or devices and this is limited due to available bandwidth. If a delay line SAW is used then the data is encoded in the length of the delay or in multiple delays and this is limited because of the additional loss of the signal due to increased delay. In addition to these problems the size of the device will increase with the number of elements within it, and therefore the cost.

This causes a problem if passive sensors are used that require calibration or product identification that needs to be accessed electronically. This information can be stored within a bar code or an RFID tag, which could be positioned with the sensor, however both of these options need additional equipment to read the information and therefore additional cost. Also, with a bar code the read range will be limited and line of sight only. Another method is to store the calibration data with the interrogation electronics of the sensor. The problem arises when the electronics are required to interrogate more than one sensor, there needs to be a simple way of letting it know which calibration data to use for which sensor.

### SUMMARY OF THE INVENTION

In the case of a Tire Pressure Monitoring System (TPMS), there will be a number of sensors present, one for each wheel. Accordingly, for a vehicle such as a passenger car, there may be a dozen or more sensors, or in a sensor using a three SAW pressure and temperature sensors for a passenger car application, there will be a sensor in each of the four wheels of the car and possibly the spare. All the sensors in any application may be interrogated through an antenna adjacent to each wheel location connected to a single set of electronics via an RF switching network which monitors information on all wheels present in the particular application.

The present invention provides a passive sensor arrangement comprising at least one remote passive sensor for monitoring a parameter within an environment, an interrogation system for receiving and analysing data from the or each sensor, and storage means associated with the or each sensor for storing calibration data relating to the associated sensor, the or each storage means being removably connectable to the interrogation system for providing the calibration data thereto.

In particular, the present invention concerns the calibration data for each sensor being held in a separate memory card, these memory cards being inserted into a memory panel connected to the interrogation electronics.

The system may be configured to receive a plurality of said storage means simultaneously, one for each sensor monitored by the interrogation system. In particular, the system may have a plurality of slots for receiving the storage means, such as memory card slots for receiving memory cards, the memory cards being required to remain inserted into the relevant slot whenever the corresponding sensor is in operation. Alternatively, the system may be configured to receive just a single storage means at a time, the contents of a plurality of storage means being downloadable into separate buffers of the interrogation system for reference during operation of the or each sensor. In the first mentioned arrangement, each card slot may be associated with a particular sensor location so that the calibration information carried on the card inserted therein automatically is associated with the sensor located in that position. For example each slot may be associated with a particular wheel of the vehicle. Alternatively, each memory buffer may be similarly associated with a particular sensor position, the appropriate buffer being selected by a user when inserting a memory card to download the calibration information into the interrogation system, thereby ensuring that the information transferred from that card automatically is associated with the appropriate sensor position

### BRIEF DESCRIPTION OF THE DRAWINGS

Embodiments of the present invention will now be described with reference to the accompanying drawings, in which:

FIG. 1 is a schematic diagram illustrating an embodiment of the present invention.

### DETAILED DESCRIPTION OF THE PREFERRED EMBODIMENTS

In order that the invention may be more fully understood, there will now be described an embodiment thereof, given by way of example, reference being made to the accompanying drawing, the sole FIGURE of which is a schematic illustration of a tire pressure mounting system according to the invention.

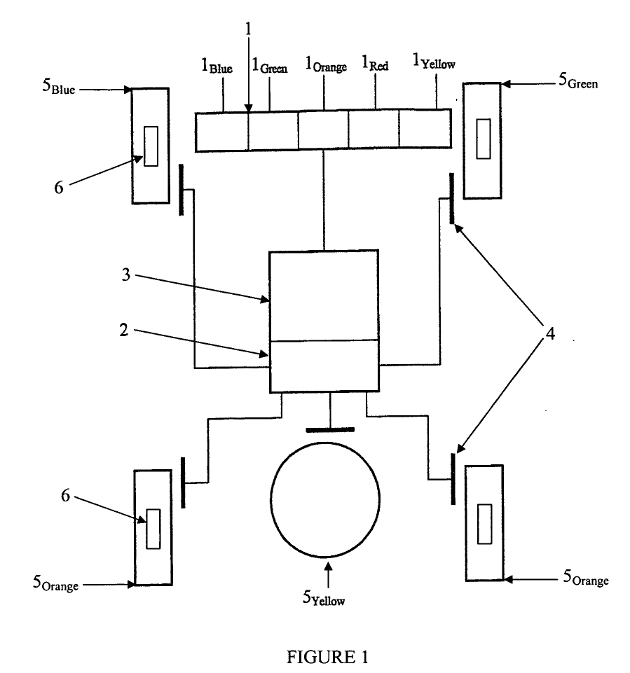

Referring to FIG. 1, the system comprises a memory panel 1 which need not be positioned with interrogation electronics 2 but instead can be connected via a simple serial connection 3. This may then allow the memory panel 1 to be positioned such that it is more easily accessible by the driver.

The system is configured to know which wheel it is measuring through use of an RF switch 4. The memory panel 1 has a plurality of slots for receiving separate memory cards, each slot 1_{Blue}, 1_{Green}, 1_{Orange}, 1_{Red}, 1_{Yellow} being associated with a particular wheel position 5_{Blue}, 5_{Green}, 5_{Orange}, 5_{Red}, 5_{Yellow} thereby associating the information on that card with the particular wheel. The benefit of such a system is that if the wheels need to be changed over or swapped with the spare no special equipment is required to re-assign the calibration data to the correct wheel. All the driver will have to do is swap over the memory cards to there new positions. Likewise if a new sensor 6 is to be fitted to the vehicle it would be supplied with is own memory card and once the sensor is fitted into the wheel its card can be inserted into the relevant slot.

The benefit in having the calibration data on a memory card that is plugged into the system is that it can then connect directly to the microprocessor within the sensor interrogation electronics, without the additional cost of an another reader that would be required if the data was stored remotely. Also because the method assigning calibration data to the relevant wheel is very simple it can be carried out by the driver without the need to take the vehicle back to a dealership.

As an additional feature the sensors/memory cards could be supplied with 5 pairs of color code markers as shown in FIG. 1. For example when all the sensor and cards are first fitted the front right valve and its memory card could be identified with blue markers, the front left valve and its memory card could be identified with green markers and so on. This would allow for easy and quick recognition of which card is associated with which wheel. The memory cards themselves could be of a smart card design or a discrete IC and pcb with an edge connector for example.

This method may not only be of use within system utilising passive sensors it could also be used in conjunction with active sensors which still require a means of informing the vehicle that the wheel positions have changed.

1-13. (canceled)

14. A passive sensor arrangement comprising:
a plurality of remote passive sensors for monitoring environmental parameters at separate locations;
an interrogation system for receiving and analyzing data from each sensor; and
storage means uniquely associated with each sensor for storing calibration data relating to the associated sensor, wherein said storage means is removably connectable to the interrogation system for providing the calibration data thereto.

15. The passive sensor arrangement according to claim 14, wherein each storage means is connectable to the interrogation system such that the information carried thereon is associated with at least one sensor at a particular location.

16. The passive sensor arrangement according to claim 14, wherein said storage means comprises one memory card which carries unique data relating to each sensor with which it is associated.

17. The passive sensor arrangement according to claim 16, further comprising a memory panel connected to said interrogation system, each memory card being insertable into said memory panel.

18. The passive sensor arrangement according to claim 17, wherein said memory panel includes a plurality of slots, each slot being associated with a particular sensor position and being suitable for receiving a single memory card at a time.

19. The passive sensor arrangement according to claim 17, wherein each said slot is uniquely associated with a single sensor position.

20. The passive sensor arrangement according to claim 17, wherein said memory panel includes a single slot into which said plurality of memory cards are individually insertable.

21. The passive sensor arrangement according to claim 17, wherein said interrogation system includes:
a plurality of internal storage means, each internal storage means being uniquely associated with a single sensor position; and
means for downloading the unique data carried by the at least one memory card inserted into the memory card slot to one of said internal storage means associated with a sensor position selected by a user upon insertion of the memory card.

22. The passive sensor arrangement according to claim 17, wherein each sensor receives data from a device located in a particular position.

23. The passive sensor arrangement according to claim 22, wherein each sensor is associated with a wheel of a car.

24. The passive sensor arrangement according to claim 14, further comprising: a set of wheels of a vehicle, each wheel having a corresponding sensor, each wheel having corresponding storage means that carries data related to the corresponding wheel.

25. A method of providing calibration information for individual sensors of a tire pressure detection system comprising the steps of:
selecting a wheel in a set of wheels of a vehicle for which calibration information is to be provided;
identifying a sensor which is assigned to monitor the selected wheel;
identifying an input in an interrogation system associated with said sensor; and
inserting into said input a memory card on which is stored the calibration information relating to the selected wheel.

26. The method according to claim 25, wherein the step of identifying the input associated with said sensor comprises identifying which of the plurality of memory card slots provided in said interrogation system is associated with the detector that monitors the selected wheel.
